(19) United States
(12) Patent Application Publication
(10) Pub. No.: US 2017/0008533 A1
(43) Pub. Date: Jan. 12, 2017

(54) CONTROL APPARATUS AND CONTROL METHOD FOR VEHICLE

(71) Applicant: TOYOTA JIDOSHA KABUSHIKI KAISHA, Toyota-shi (JP)

(72) Inventors: Hiroaki EBUCHI, Hadano-shi (JP); Akira MURAKAMI, Gotenba-shi (JP); Yuji IWASE, Mishima-shi (JP); Shotaro KATO, Susono-shi (JP); Hidekazu NAGAI, Susono-shi (JP); Hiroto HASHIMOTO, Susono-shi (JP)

(73) Assignee: TOYOTA JIDOSHA KABUSHIKI KAISHA, Toyota-shi (JP)

(21) Appl. No.: 15/205,737

(22) Filed: Jul. 8, 2016

(30) Foreign Application Priority Data
Jul. 10, 2015 (JP) 2015-139185

(51) Int. Cl. B60W 30/20; B60K 6/50; F16D 48/06; B60W 20/00; B60W 10/08; B60W 10/02; B60W 10/184; B60K 6/38; F16H 3/72

(52) U.S. Cl. CPC B60W 30/20; B60K 6/38; B60K 6/50; F16D 48/06; F16H 3/724; B60W 10/08; B60W 10/02; B60W 10/184; B60W 20/00; Y10S 903/93; Y10S 903/912; Y10S 903/915; B60Y 2200/92; B60Y 2300/205; B60Y 2300/42; B60Y 2300/43; B60Y 2300/60; B60W 2030/206; B60W 2510/0208; B60W 2510/0657; B60W 2710/021; B60W 2710/083

(57) ABSTRACT

an electronic control unit configured to i) while the engagement mechanism is changing from the engaged state to the released state, execute shaking control, ii) execute torque oscillation control, iii) determine whether to execute any one of releasing control and the torque oscillation control while the other one of the releasing control and the torque oscillation control is being executed, and iv) stop the shaking control when the electronic control unit determines to execute the releasing control and the torque oscillation control.

### INCORPORATION BY REFERENCE

The disclosure of Japanese Patent Application No. 2015-139185 filed on Jul. 10, 2015 including the specification, drawings and abstract is incorporated herein by reference in its entirety.

### BACKGROUND OF THE INVENTION

1. Field of the Invention

The invention relates to a control apparatus and control method for a vehicle.

2. Description of Related Art

Conventionally, there is known a control apparatus that controls a meshing-type engagement mechanism as an apparatus that controls a vehicle.

For example, Japanese Patent Application Publication No. 2012-193851 (JP 2012-193851 A) describes a control apparatus for a vehicle including a motor and a meshing-type engagement mechanism. This control apparatus is configured to execute control for repeatedly increasing and reducing a motor torque during releasing control. Thus, a torque that acts from the motor on the engagement mechanism oscillates, so the torque reduces a load that occurs between meshing members. Therefore, the engagement mechanism is easily released.

### SUMMARY OF THE INVENTION

However, with the configuration described in JP 2012-193851 A, torque fluctuations generated on a drive wheel side transmit to the engagement mechanism via a power transmission path, so there is a case where a load that actually occurs between the meshing members is uncertain. In this case, if control for repeatedly increasing and reducing the motor torque is executed, there is a possibility that the engagement mechanism is difficult to be released instead.

Aspects of the invention are contemplated in view of the above situation, and provide a control apparatus and control method for a vehicle, which allow a meshing-type engagement mechanism to be easily released even in a case where torque fluctuations generated on a drive wheel side act on the engagement mechanism.

A first aspect of the invention provides a control apparatus for a vehicle. The vehicle includes an engine, a motor, an engagement mechanism configured to change between an engaged state where a pair of meshing members are engaged with each other and a released state where the meshing members are released from each other, a driveline configured to transmit an engine torque output from the engine to drive wheels, and a braking device configured to impart braking force to each of the drive wheels. When the engagement mechanism is in the engaged state, the engine torque, a motor torque output from the motor, and a torque that is transmitted from the drive wheels via the driveline are transmitted to the meshing members. The control apparatus includes an electronic control unit configured to i) while the engagement mechanism is changing from the engaged state to the released state, execute shaking control, the shaking control being control for causing the motor to output a torque for reducing a load on the meshing members, which occurs due to the engine torque, and repeatedly increasing and reducing a magnitude of the motor torque within a predetermined range, ii) execute torque oscillation control, the torque oscillation control being control for oscillating a torque of the drive wheels by using the braking device, iii) determine whether to execute any one of releasing control and the torque oscillation control while the other one of the releasing control and the torque oscillation control is being executed, the releasing control being control for changing the engagement mechanism from the engaged state to the released state, and iv) stop the shaking control when the electronic control unit determines to execute the releasing control and the torque oscillation control.

With the control apparatus for a vehicle according to the first aspect of the invention, when the torque of the drive wheels oscillates as a result of execution of the torque oscillation control by the electronic control unit, the torque oscillations transmit from the drive wheels to the meshing members of the engaged engagement mechanism via the driveline. For this reason, when the electronic control unit executes the releasing control and the torque oscillation control, the electronic control unit stops the shaking control. Thus, when the torque oscillations from the drive wheel side transmit to the meshing members of the engagement mechanism, the electronic control unit is able to prevent or reduce an increase in load that occurs between the meshing members resulting from execution of the shaking control. Therefore, it is possible to easily release the meshing-type engagement mechanism.

In the first aspect of the invention, the electronic control unit may be configured to v) estimate the load based on the engine torque, and execute estimation control, the estimation control is control for estimating a magnitude of a torque that cancels out the estimated load, and vi) execute control for keeping the magnitude of the motor torque at the magnitude of the torque estimated through the estimation control, when the electronic control unit determines to execute the releasing control and the torque oscillation control.

With the control apparatus for a vehicle according to the first aspect of the invention, the electronic control unit estimates the load that occurs between the meshing members based on the engine torque, and keeps the magnitude of the torque that is output from the motor at the magnitude of the torque, which cancels out the estimated load. Thus, it is possible to reduce the load that occurs between the meshing members by utilizing the torque oscillations that transmit from the drive wheel side to the engagement mechanism as a result of execution of the torque oscillation control by the electronic control unit.

A second aspect of the invention provides a control method for a vehicle. The vehicle includes an engine, a motor, a meshing-type engagement mechanism configured to change between an engaged state where a pair of meshing members are engaged with each other and a released state where the meshing members are released from each other, a driveline configured to transmit an engine torque, output from the engine, to drive wheels, a braking device configured to impart braking force to each of the drive wheels, and an electronic control unit configured to, when the engagement mechanism is in the engaged state, control the vehicle such that the engine torque, a motor torque output from the motor, and a torque that is transmitted from the drive wheels via the driveline are transmitted to the meshing members. The control method includes i) while the engagement mechanism is changing from the engaged state to the released state, executing shaking control, the shaking control being control for causing the motor to output a torque for reducing a load on the meshing members, which occurs due to the engine torque, and repeatedly increasing and reducing a magnitude of the motor torque within a predetermined range; ii) executing torque oscillation control, the torque oscillation control being control for oscillating a torque of the drive wheels by using the braking device, iii) determining whether to execute any one of releasing control and the torque oscillation control while the other one of the releasing control and the torque oscillation control is being executed, the releasing control being control for changing the engagement mechanism from the engaged state to the released state; and iv) stopping the shaking control when execution of the releasing control and the torque oscillation control is determined.

With the control method for a vehicle according to the second aspect of the invention, when the torque of the drive wheels oscillates as a result of execution of the torque oscillation control, the torque oscillations transmit from the drive wheels to the meshing members of the engaged engagement mechanism via the driveline. For this reason, when the releasing control and the torque oscillation control are executed, the shaking control is stopped. Thus, when the torque oscillations from the drive wheel side act on the engagement mechanism, it is possible to prevent or reduce an increase in load that occurs between the meshing members resulting from execution of the shaking control. Therefore, it is possible to easily release the meshing-type engagement mechanism.

In the second aspect of the invention, the control method may further include v) estimating the load on the basis of the engine torque, and estimating a magnitude of a torque that cancels out the estimated load; and vi) executing control for keeping the magnitude of the motor torque at the magnitude of the estimated torque, when the execution of the releasing control and the torque oscillation control is determined.

With the control method for a vehicle according to the second aspect of the invention, the load that acts between the meshing members is estimated on the basis of the engine torque, and the magnitude of the torque that is output from the motor is kept at the magnitude of the torque, which cancels out the estimated load. Thus, it is possible to reduce the load that occurs between the meshing members by utilizing the torque oscillations that transmit from the drive wheel side to the engagement mechanism as a result of execution of the torque oscillation control.

According to the aspects of the invention, when control for oscillating the driving torque intervenes during the releasing control, the shaking control for changing the magnitude of the motor torque within the predetermined range is stopped. Thus, it is possible to prevent a situation that the engagement mechanism is difficult to be released as a result of execution of the shaking control during the torque oscillation control, and to reduce the load of the engagement mechanism by using the torque oscillations that act from the drive wheel side, so it is possible to easily release the engagement mechanism. In addition, it is possible to reduce electric power that is consumed to execute the shaking control, so it is possible to improve fuel economy.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a skeletal view that schematically shows a vehicle according to an embodiment;

FIG. 2 is a cross-sectional view that shows an example of a dog clutch;

FIG. 3 is a block diagram that schematically shows a control apparatus for a vehicle according to the embodiment;

FIG. 4 is a nomograph that shows an engine driving state where the dog clutch is engaged;

FIG. 5 is an explanatory view for illustrating a load that occurs in a meshing portion;

FIG. 6 is a timing chart that shows a change in torque that acts on the dog clutch while shaking control is being executed;

FIG. 7 is a flowchart that shows an example of a control procedure that the control apparatus for a vehicle executes while the dog clutch is being released;

FIG. 8 is a timing chart that shows a change in torque that acts on the dog clutch in the case where torque oscillation control intervenes during shaking control;

FIG. 9 is a timing chart that shows a change in torque that acts on the dog clutch in the case where torque oscillation control intervenes before the start of shaking control;

FIG. 10 is a skeletal view that schematically shows a first alternative embodiment of the vehicle;

FIG. 11 is a skeletal view that schematically shows a second alternative embodiment of the vehicle;

FIG. 12 is a skeletal view that schematically shows a third alternative embodiment of the vehicle; and

FIG. 13 is a skeletal view that schematically shows a fourth alternative embodiment of the vehicle.

### DETAILED DESCRIPTION OF EMBODIMENTS

Hereinafter, a control apparatus and control method for a vehicle according to an embodiment of the invention will be specifically described with reference to the accompanying drawings.

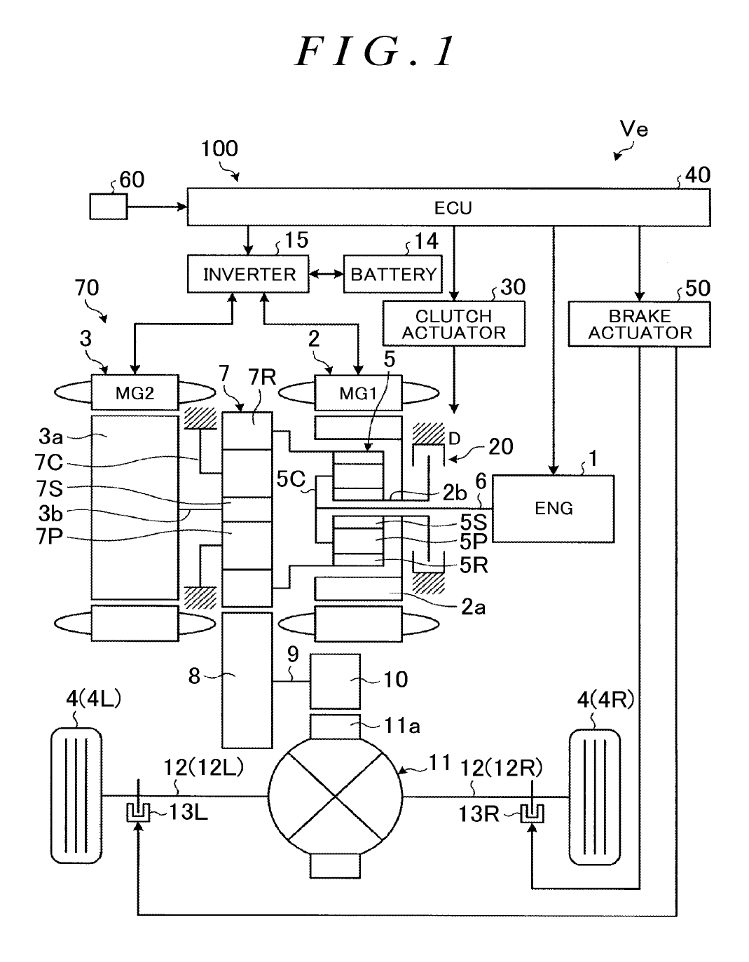

FIG. 1 is a skeletal view that schematically shows a vehicle according to the present embodiment. The vehicle Ve is configured such that an engine 1, a first motor generator 2 and a second motor generator 3 function as power sources. The engine 1 is a known internal combustion engine, such as a gasoline engine and a diesel engine. Each of the motor generators 2, 3 is a known motor having a motor function of outputting power when supplied with electric power and a power generating function of generating electric power when forcibly rotated by mechanical external force. For example, each of the motor generators 2, 3 is a permanent magnet synchronous motor, or the like. In the following description, each motor generator is simply referred to as motor.

A driveline (powertrain) 70 of the vehicle Ve includes a power split mechanism 5 in a power transmission path from the engine 1 to drive wheels 4, and is configured to be able to distribute power output from the engine 1 to the first motor 2 side and the drive wheels 4 side. The first motor 2 is caused to function as a generator by power distributed to the first motor 2 side, and the second motor 3 is driven by the generated electric power. Thus, power output from the second motor 3 is allowed to be added to power distributed to the drive wheels 4 side.

The power split mechanism 5 is formed of a differential mechanism including a plurality of rotating elements, and, more specifically, formed of a single-pinion planetary gear train. The power split mechanism 5 includes a sun gear 5S, a ring gear 5R and a carrier 5C as three rotating elements. The ring gear 5R is arranged concentrically with respect to the sun gear 5S. The carrier 5C holds pinion gears 5R such that the pinion gears 5P are rotatable and revolvable. Each of the pinion gears 5P is in mesh with the sun gear 5S and the ring gear 5R.

The first motor 2 is coupled to the sun gear 5S. The first motor 2 has a rotor shaft (hereinafter, may be referred to as MG1 shaft) 2b that rotates integrally with a rotor 2a. The sun gear 5S is coupled to the MG1 shaft 2b so as to rotate integrally with the MG1 shaft 2b. The engine 1 is coupled to the carrier 5C. An output shaft (crankshaft) 6 of the engine 1 is coupled to the carrier 5C so as to rotate integrally with the carrier 5C. The ring gear 5R is an output element that outputs power from the power split mechanism 5 to the drive wheels 4 side. A ring gear 7R of a transmission unit 7 (described later) is coupled to the ring gear 5R so as to rotate integrally with the ring gear 5R.

The vehicle Ve is configured to be able to add a torque output from the second motor 3 to a torque that is transmitted from the engine 1 to the drive wheels 4 via the power split mechanism 5. The transmission unit 7 is provided in a power transmission path from the second motor 3 to the drive wheels 4. The transmission unit 7 is formed of a differential mechanism including a plurality of rotating elements.

The transmission unit 7 is formed of a single-pinion planetary gear train. The transmission unit 7 includes a sun gear 7S, the ring gear 7R and a carrier 7C as three rotating elements. The ring gear 7R is arranged concentrically with respect to the sun gear 7S. The carrier 7C holds pinion gears 7P such that the pinion gears are rotatable and revolvable. Each of the pinion gears 7P is in mesh with these sun gear 7S and ring gear 7R. The internal teeth of the ring gear 7R are in mesh with the pinion gears 7P.

The second motor 3 is coupled to the sun gear 7S. The second motor 3 has a rotor shaft 3b that rotates integrally with a rotor 3a. The sun gear 7S is coupled to the rotor shaft 3b so as to rotate integrally with the rotor shaft 3b. The carrier 7C is fixed to a fixed portion, such as a housing, so as to be non-rotatable. The ring gear 7R outputs a torque output from the second motor 3 from the transmission unit 7 to the drive wheels 4 side. The external teeth of the ring gear 7R are in mesh with a counter driven gear 8. That is, the ring gear 7R is an output gear that outputs a torque from the power sources (the engine 1 and the motors 2, 3) to the drive wheels 4 side.

The counter driven gear 8 is connected to a counter shaft 9 so as to rotate integrally with the counter shaft 9. The counter shaft 9 is arranged parallel to the rotation central axes of the engine 1, the motors 2, 3, and the like. A counter drive gear 10 is connected to the counter shaft 9 so as to rotate integrally with the counter shaft 9. The counter drive gear 10 is a gear having a smaller diameter than the counter driven gear 8, and is in mesh with a ring gear 11a of a differential 11 that is a final reduction gear. Drive shafts 12 are coupled to the differential 11. The drive shafts 12 are arranged parallel to the rotation central axes of the engine 1, the motors 2, 3, and the like, and rotate integrally with the corresponding drive wheels 4. That is, the vehicle Ve shown in FIG. 1 is configured as an FF system in which the power sources are arranged at the vehicle front and front wheels generate a driving torque T_{d}.

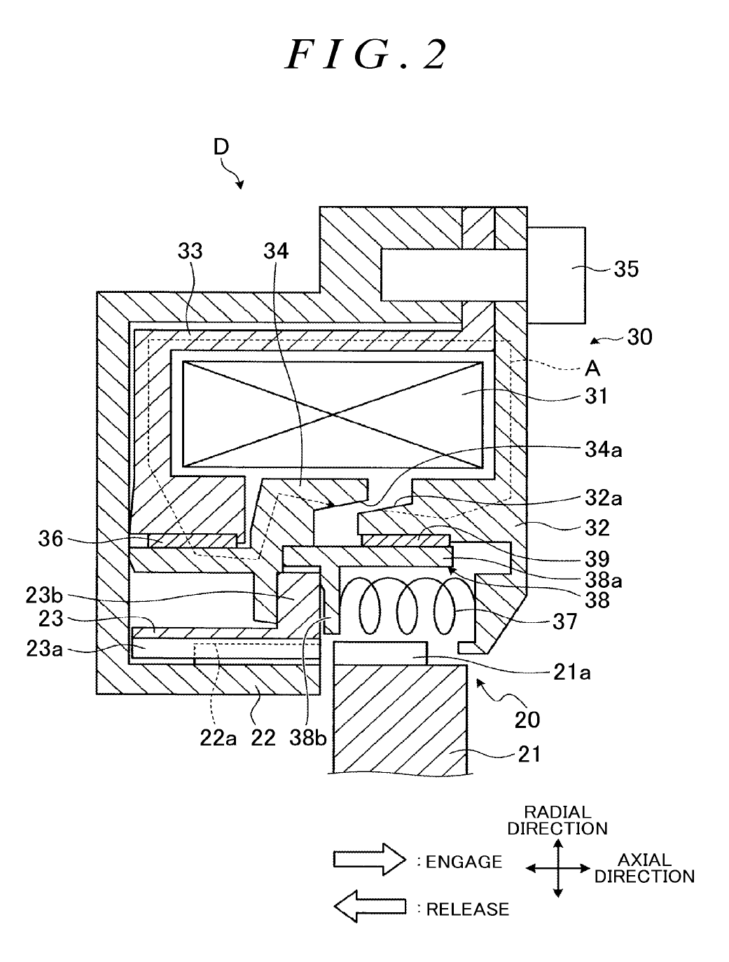

The vehicle Ve includes a dog clutch D that selectively fixes the MG1 shaft 2b and the sun gear 5S such that the MG1 shaft 2b and the sun gear 5S are non-rotatable. The dog clutch D is a meshing-type engagement mechanism configured such that meshing members are engaged with each other or released from each other in a meshing portion 20. The vehicle Ve is configured such that, when the dog clutch D is engaged, an engine torque Tₑ, an MG1 torque T_{mg1} and a torque that is transmitted from the drive wheels 4 via the driveline 70 are generated between the meshing members of the meshing portion 20. The engine torque is a torque output from the engine 1. The MG1 torque is a torque output from the first motor 2. The dog clutch D is actuated by a clutch actuator 30, and is changed between an engaged state and a released state. The clutch actuator 30 is controlled by a control apparatus 100 for a vehicle, which controls the vehicle Ve. The details of the dog clutch D and clutch actuator 30 will be described later with reference to FIG. 2.

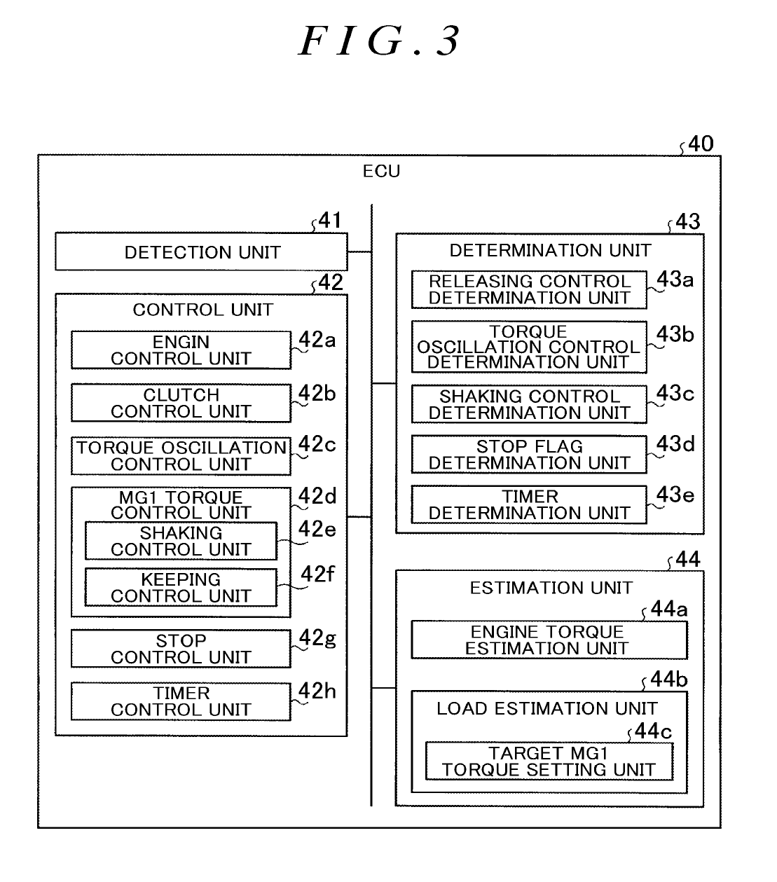

The control apparatus 100 for a vehicle includes an electronic control unit (hereinafter, referred to as ECU) 40. The ECU 40 is configured to control the engine 1, the motors 2, 3, the dog clutch D, and a braking device that imparts braking force to each of the drive wheels 4. The vehicle Ve includes a right wheel brake 13R and a left wheel brake 13L as the braking device. The right wheel brake 13R imparts braking force to the right drive wheel 4R. The left wheel brake 13L imparts braking force to the left drive wheel 4L. Each of the brakes 13R, 13L is actuated by a brake actuator 50. In the vehicle Ve, the ECU 40 is able to impart braking forces having different magnitudes respectively to the drive wheels 4R, 4L by controlling the brake actuator 50. Electric power stored in a battery 14 is supplied to each of the motors 2, 3 via an inverter 15. Each of the motors 2, 3 is electrically connected to the battery 14 and the other motor via the inverter 15. In the vehicle Ve, the ECU 40 is able to cause each of the motors 2, 3 to function as a generator or a motor by controlling the inverter 15. In addition, signals output from various in-vehicle sensors 60 are input to the ECU 40. For example, signals from a vehicle sensor that detects a vehicle speed, a sensor that detects the rotation speed of the output shaft 6 of the engine 1, and the like, are input. The details of the ECU 40 will be described later with reference to FIG. 3.

FIG. 2 is a cross-sectional view that shows an example of the dog clutch D and clutch actuator 30. The dog clutch D includes a hub 21 and a fixed member 22 as a pair of meshing members. In the released state shown in FIG. 2, in the meshing portion 20, spline teeth 23a provided on the inner periphery of a sleeve 23 are in mesh with spline teeth 22a provided on the outer periphery of the fixed member 22. However, the spline teeth 23a are not in mesh with spline teeth 21a provided on the outer periphery of the hub 21. The sleeve 23 has a cylindrical shape, and is configured to be movable in its axial direction. For this reason, in the engaged meshing portion 20, the spline teeth 23a of the sleeve 23 are in mesh with the spline teeth 21a of the hub 21 and the spline teeth 22a of the fixed member 22. The hub 21 is spline-fitted to the MG1 shaft 2b, and rotates integrally with the MG1 shaft 2b. The fixed member 22 is formed of the fixed portion, such as the housing. Thrust in the axial direction (engaging direction) is imparted from the electromagnetic clutch actuator 30 to the sleeve 23. That is, the dog clutch D is of an electromagnetic type, and is configured such that the pair of meshing members (the hub 21 and the fixed member 22) are engaged with each other via the sleeve 23.

When current is applied to an electromagnetic coil 31 of the clutch actuator 30, a magnetic field is generated around the electromagnetic coil 31. The clutch actuator 30 is configured such that an armature 34 is moved in the axial direction as the magnetic field forms a magnetic flux path A that passes through yokes 32, 33 and the armature 34. A boss 23b of the sleeve 23 receives a load in the axial direction (engaging direction) from the armature 34. Thus, the sleeve 23 and the armature 34 integrally move in the axial direction. The magnetic flux path A passes through a gap between a magnetism attraction face 34a of the armature 34 and a magnetism attraction face 32a of the first yoke 32. The magnetism attraction face 34a and the magnetism attraction face 32a face each other in the axial direction, and are formed into tapered faces that face each other in the radial direction. Each of the yokes 32, 33 is made of a magnetic material. The yokes 32, 33 are arranged so as to surround the electromagnetic coil 31, and are fixed to the fixed member 22 by a bolt 35. The armature 34 is supported by the second yoke 33 via a bush 36, and is configured to be movable in the axial direction.

The elastic force of a return spring 37 acts on the sleeve 23 via a plunger 38. The plunger 38 has a cylindrical portion 38a and a projecting portion 38b that projects radially inward from the inner periphery of the cylindrical portion 38a. The cylindrical portion 38a of the plunger 38 is supported by the first yoke 32 via a bush 39, and is configured to be movable in the axial direction. The return spring 37 is sandwiched between the projecting portion 38b and the first yoke 32, and generates elastic force in a releasing direction in the axial direction. Therefore, when thrust that is imparted from the clutch actuator 30 is larger than elastic force that is received from the return spring 37, the sleeve 23 moves in the engaging direction against the elastic force. When the thrust is smaller than the elastic force, the sleeve 23 moves in the releasing direction due to the elastic force. Because the plunger 38 is made of a non-magnetic material, the magnetic flux path A does not pass through the plunger 38. Thus, the magnetic flux path A passes through the magnetism attraction faces 32a, 34a arranged on the radially outer side of the plunger 38, and it is possible to prevent the return spring 37 from being excited.

FIG. 3 is a functional block diagram for illustrating functional units of the ECU 40. The ECU 40 is mainly formed of a microcomputer, and executes computation in accordance with a predetermined program on the basis of input data and prestored data. The ECU 40 outputs various command signals according to the computation result.

The ECU 40 includes a detection unit 41, a control unit 42, a determination unit 43 and an estimation unit 44. The detection unit 41 detects input signals from the sensors 60. The control unit 42 executes various controls. The determination unit 43 determines whether various conditions are satisfied. The estimation unit 44 estimates the operations or states of controlled objects. These units 41 to 44 are connected to one another via a communication bus, or the like, so as to be able to transmit or receive signals to or from each other.

The detection unit 41 detects the signals that are input from the sensors 60 to the ECU 40 and command signals that are output from the ECU 40 to the controlled objects. For example, the detection unit 41 detects a command signal that is output from the ECU 40 to the engine 1. The command signal includes an engine torque command value for controlling the engine torque Tₑ.

The control unit 42 includes an engine control unit 42a, a clutch control unit 42b, a torque oscillation control unit 42c, an MG1 torque control unit 42d, a shaking control unit 42e, a keeping control unit 42f, a stop control unit 42g and a timer control unit 42h.

The engine control unit 42a executes engine control over the engine 1 as a controlled object. The engine control unit 42a controls fuel supply amount, intake air amount, fuel injection, ignition timing, and the like. For example, the engine control unit 42a is configured to compute a required driving force on the basis of an accelerator operation amount and a vehicle speed and then compute an engine torque command value that satisfies the required driving force. The magnitude of the engine torque Tₑ is controlled on the basis of the engine torque command value. The required driving force and the engine torque command value are obtained by using a known computation method, such as a method in which the required driving force or the engine torque command value is determined on the basis of a map stored in advance.

The clutch control unit 42b executes clutch control over the dog clutch D as a controlled object. The clutch control unit 42b executes engaging control for changing the dog clutch D from the released state to the engaged state by controlling the clutch actuator 30. In addition, the clutch control unit 42b executes releasing control for changing the dog clutch D from the engaged state to the released state. For example, when the clutch control unit 42b executes releasing control, energization of the electromagnetic coil 31 is interrupted. By interrupting energization of the electromagnetic coil 31, thrust is not generated in the clutch actuator 30. Thus, the sleeve 23 moves in the releasing direction under the elastic force of the return spring 37, so a meshed state (engaged state) of the hub 21 with the fixed member 22 is cancelled.

The torque oscillation control unit 42c executes torque oscillation control over each of the brakes 13R, 13L as a controlled object. Torque oscillation control is control for oscillating the driving torque T_{d} by imparting braking force to each of the drive wheels 4. The torque oscillation control unit 42c imparts braking forces having different magnitudes respectively to the drive wheels 4 to oscillate the driving torque T_{d} by controlling the brake actuator 50. The torque oscillation control includes controls, such as anti-lock brake system (ABS), traction control (TRC) and vehicle stability control (VSC). The ABS is to prevent or reduce locking of the drive wheels 4 during braking. The TRC is to prevent or reduce spinning of the drive wheels 4 during acceleration. The VSC is to stabilize the cornering attitude (behavior) of the vehicle Ve during steering operation. For example, in the case of the ABS, even when a driver requires the drive wheels 4 to generate large braking force by depressing a brake pedal, torque oscillation control intervenes in a change in the torque of each drive wheel 4 according to the braking request. Thus, a steep change in torque (steep increase in braking force) is prevented. In short, torque oscillation control intervenes in a change in the torque of each drive wheel 4 according to a driver's request.

The MG1 torque control unit 42d executes MG1 torque control over the first motor 2 as a controlled object. The MG1 torque control unit 42d controls the direction and magnitude of the MG1 torque T_{mg1} by controlling the inverter 15. The MG1 torque control unit 42d includes the shaking control unit 42e and the keeping control unit 42f.

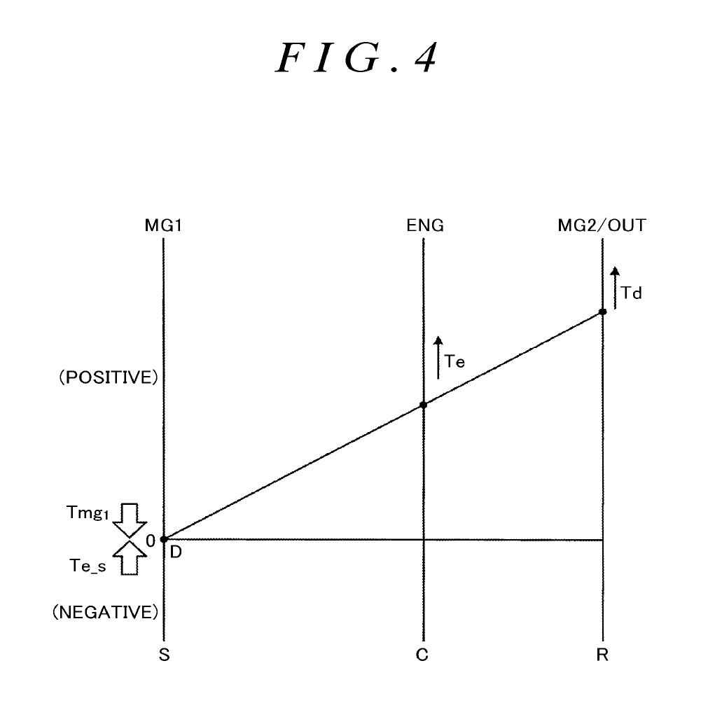

The shaking control unit 42e executes shaking control while the clutch control unit 42b is executing releasing control. The shaking control is control for causing the first motor 2 to output a torque for reducing a load F that occurs in the meshing portion 20 and repeatedly increasing and reducing the magnitude of the MG1 torque T_{mg1} within a predetermined range. In shaking control, the MG1 torque T_{mg1} is increased or reduced with respect to a predetermined target value. That is, the shaking control unit 42e controls the MG1 torque T_{mg1} to a state having a deviation from the target value. The details of shaking control and estimated zero load value will be described later with reference to FIG. 4, and the like.

The keeping control unit 42f executes keeping control while the clutch control unit 42b is executing releasing control. The keeping control is control for keeping the MG1 torque T_{mg1} at the target value. For example, when the target value is a fixed value, the MG1 torque T_{mg1} is fixed to the target value by the keeping control unit 42f. Alternatively, when the target value changes in response to a vehicle state, the MG1 torque T_{mg1}is kept at the target value by the keeping control unit 42f; however, the MG1 torque T_{mg1} is also changing with a change in the target value. In short, the keeping control unit 42f controls the MG1 torque T_{mg1}to a state having no deviation from the target value.

The stop control unit 42g executes stop control for stopping shaking control of the shaking control unit 42e. The stop control unit 42g sets a stop flag to an on state when the stop control unit 42g executes stop control. The shaking control unit 42e is configured not to be allowed to start shaking control when the stop flag is set to the on state. The stop control unit 42g may be configured to be allowed to end stop control and set the stop flag to an off state when a predetermined resumption condition is satisfied.

The timer control unit 42h controls a timer tₐ when the stop flag is in the on state. For example, the timer control unit 42h sets the timer tₐ to zero at the start of stop control. The timer control unit 42h counts up the timer tₐ while the stop control unit 42g is executing stop control.

The determination unit 43 includes a stop control determination unit 43a, a torque oscillation control determination unit 43b, a shaking control determination unit 43c, a stop flag determination unit 43d and a timer determination unit 43e.

The stop control determination unit 43a determines whether the clutch control unit 42b is executing releasing control. The stop control determination unit 43a is able to determine that the dog clutch D is changing from the engaged state to the released state. The clutch actuator 30 may include a stroke sensor that detects the stroke amount of the sleeve 23 or armature 34. A signal output from the stroke sensor is input to the ECU 40, and the stop control determination unit 43a determines whether the dog clutch D is released. Alternatively, a sensor that detects the amount of energization of the electromagnetic coil 31 may be provided. The stop control determination unit 43a may be configured to determine that the dog clutch D is erroneously released on the basis of the signal that is input from the sensor.

The torque oscillation control determination unit 43b determines whether a condition for executing torque oscillation control is satisfied. The torque oscillation control determination unit 43b determines whether the torque oscillation control unit 42c executes torque oscillation control while the clutch control unit 42b is executing releasing control. That is, the torque oscillation control determination unit 43b determines whether torque oscillation control intervenes while the clutch control unit 42b is executing releasing control. The torque oscillation control determination unit 43b determines whether the clutch control unit 42b executes releasing control while the torque oscillation control unit 42c is executing torque oscillation control. In short, the torque oscillation control determination unit 43b is configured to determine whether to execute any one of releasing control and torque oscillation control while the other one of releasing control and torque oscillation control is being executed.

The shaking control determination unit 43c determines whether the shaking control unit 42e is executing shaking control. That is, the shaking control determination unit 43c determines whether the dog clutch D is being subjected to releasing control and the first motor 2 is being subjected to shaking control. The time during releasing control means the time during the progress of changing the dog clutch D from the engaged state to the released state.

The stop flag determination unit 43d determines whether the stop flag is in the on state while the clutch control unit 42b is executing releasing control.

The timer determination unit 43e determines whether the timer tₐ is longer than a prescribed time tₛ. The prescribed time tₛ is set to a value longer than zero. For example, when the timer tₐ is set to zero by the timer control unit 42h, the timer determination unit 43e makes negative determination that the timer tₐ is shorter than the prescribed time tₛ.

The estimation unit 44 includes an engine torque estimation unit 44a, a load estimation unit 44b and a target MG1 torque setting unit 44c. The load estimation unit 44b includes the target MG1 torque setting unit 44c.

The engine torque estimation unit 44a estimates a torque that is actually output from the engine 1 on the basis of the engine torque command value. The estimation method may be a known method. In this description, a torque that is actually output from the engine 1 is referred to as actual engine torque, and a torque estimated by the engine torque estimation unit 44a is referred to as estimated engine torque.

The load estimation unit 44b estimates the load F that occurs in the meshing portion 20 as a result of the fact that the engine torque Tₑ acts on the engaged dog clutch D. The load F is a load in a rotation direction in which the meshing members push each other. The load estimation unit 44b calculates the load F as an estimated value by using the estimated engine torque that is obtained by the engine torque estimation unit 44a and the speed ratio (gear ratio) of the power split mechanism 5. For example, the load F is obtained by multiplying the estimated engine torque by the speed ratio. The load estimation unit 44b estimates an estimated value (hereinafter, referred to as estimated zero load value) T_{tgt} of the MG1 torque T_{mg1} that cancels out the load F. For example, the estimated zero load value T_{tgt} is a motor torque that has a magnitude equal to the load F estimated on the basis of the estimated engine torque and that acts in the direction to reduce the load F.

The target MG1 torque setting unit 44c sets the estimated zero load value T_{tgt} for a target value of the MG1 torque T_{mg1}. When the target value is set to the estimated zero load value T_{tgt} by the target MG1 torque setting unit 44c, a reference value of control that is executed by the shaking control unit 42e and the keeping control unit 42f is set.

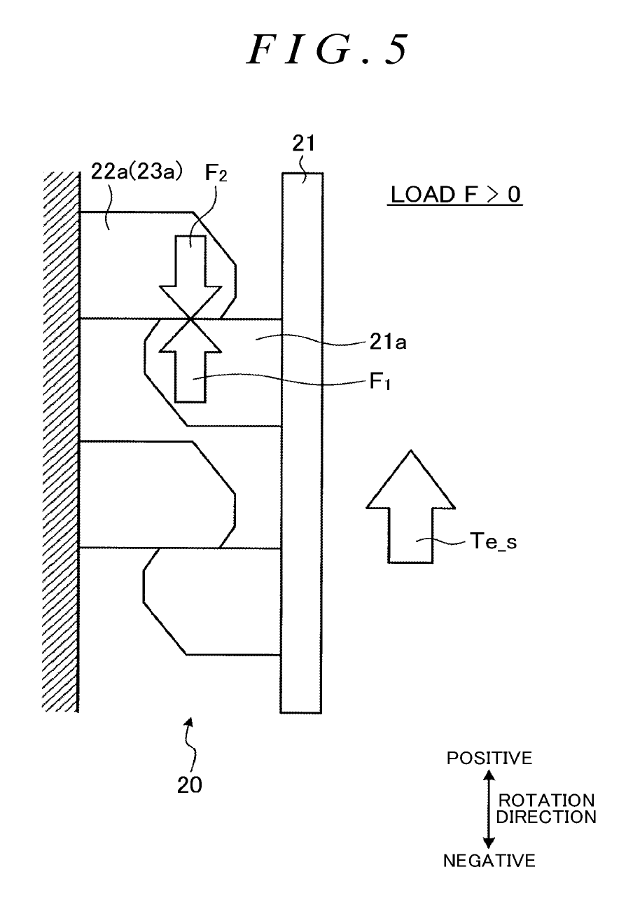

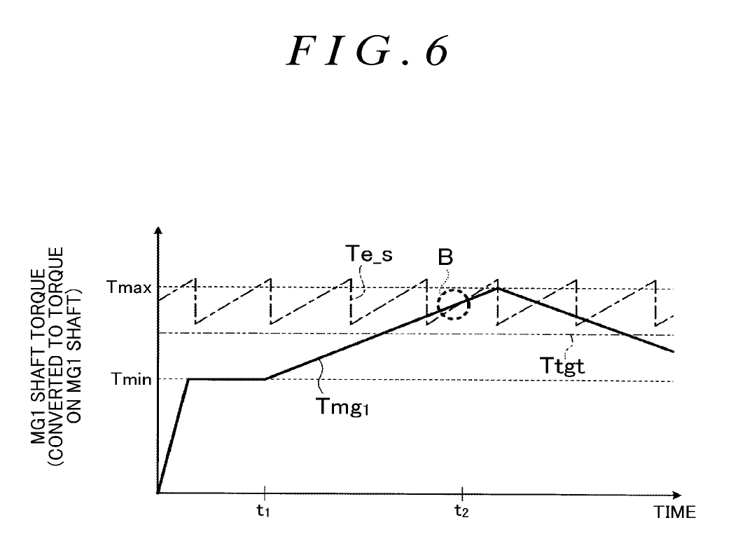

Shaking control will be described with reference to FIG. 4, FIG. 5 and FIG. 6. FIG. 4 is a nomograph that shows an engine driving state while the dog clutch D is engaged. In FIG. 4, for each of the rotating elements of the power split mechanism 5, the sun gear 5S is indicated by “S”, the carrier 5C is indicated by “C”, and the ring gear 5R is indicated by “R”. In the driving state shown in FIG. 4, the driving torque T_{d} is generated at the drive wheels 4 on the basis of the engine torque Tₑ. Because the dog clutch D is in the engaged state, the sun gear 5S is non-rotatable. A positive input torque Tₑ_{_}ₛ caused by the engine torque Tₑ acts on the fixed sun gear 5S. The load F occurs due to the input torque Tₑ_{_}ₛ (engine torque Tₑ) between the meshing members of the meshing portion 20. In order to reduce the load F in shaking control, the shaking control unit 42e causes the first motor 2 to output the MG1 torque T_{mg1} that acts in a direction opposite to the input torque Tₑ_{_}ₛ that is the cause of the load F. The principle of occurrence of the load F is shown in FIG. 5.

A positive torque is a torque that acts in a direction to rotate a rotary member in a positive direction. Positive rotation is the same direction as the rotation direction of the engine 1 (the rotation direction of the crankshaft). Negative rotation is a direction opposite to the rotation direction of the engine 1. A negative torque is a torque that acts in a direction to rotate a rotary member in a negative direction. In FIG. 4, the upward-directed arrow indicates positive torque, and the downward-directed arrow indicates negative torque.

FIG. 5 is a conceptual view for illustrating the load F that occurs in the meshing portion 20 on the basis of the engine torque Tₑ. The state shown in FIG. 5 is a state where the MG1 torque T_{mg1} is not acting on the hub 21. As the positive input torque Tₑ_{_}ₛ acts on the hub 21, the load F occurs in the engaged meshing portion 20. The load F is a load in the rotation direction in which the spline teeth 21a of the hub 21 and the spline teeth 22a of the fixed member 22 push each other. That is, a state where the load F is occurring is a state where a load in the rotation direction in which the meshing members push each other in the meshing portion 20 is occurring. More specifically, a positive load F₁ that the spline teeth 21a of the hub 21 push the spline teeth 22a of the fixed member 22 and a negative load F₂ that occurs in order for the fixed member 22 to restrict rotation of the hub 21 occur. In short, as a result of the fact that the hub 21 that has received the input torque Tₑ_{_}ₛ causes the positive load F₁ to act on the fixed member 22, the negative load F₂ occurs as a reaction. Because the hub 21 is not rotating, the load F₁ and the load F₂ balance with each other in magnitude. The spline teeth 21a of the hub 21 may be regarded as one of the meshing members, and the spline teeth 22a of the fixed member 22 may be regarded as the other one of the meshing members. Because the sleeve 23 is spline-fitted to the fixed member 22 while the dog clutch D is in the released state, the spline teeth 23a of the sleeve 23 may be regarded as the other one of the meshing members.

As shown in FIG. 4, the ECU 40 executes shaking control, and causes the first motor 2 to output the MG1 torque T_{mg1} that acts in a direction to reduce the load F, that is, a direction opposite to the input torque Tₑ_{_}ₛ. When the meshing members are fixed to each other in the meshing portion 20, the direction to reduce the load F is a direction opposite to the direction of the input torque Tₑ_{_}ₛ. In addition, the ECU 40 changes the magnitude of the MG1 torque T_{mg1} within the predetermined range. FIG. 6 shows a change in torque in the case where shaking control is executed.

FIG. 6 is a timing chart that shows a change in torque that acts on the MG1 shaft 2b during shaking control. The relationship between the positive input torque Tₑ and the negative MG1 torque T_{mg1} will be described as a torque that acts on the MG1 shaft 2b. For the sake of convenience of description, the MG1 torque T_{mg1} that is the negative torque is shown in absolute value in FIG. 6.

As shown in FIG. 6, the input torque Tₑ_{_}ₛ oscillates as the engine 1 is driven. The first motor 2 is shut down while the dog clutch D is in the engaged state. For this reason, at the time of starting shaking control, control for returning the shut-down first motor 2 is executed. Through the return control, the MG1 torque T_{mg1} is controlled to a lower limit value Tₘᵢₙ of a shaking range. The shaking control unit 42e increases the MG1 torque T_{mg1} to the lower limit value Tₘᵢₙ, and then starts shaking control (time t₁).

In shaking control, the magnitude of the MG1 torque T_{mg1} is changed within a predetermined torque range. The torque range is set with reference to the estimated zero load value T_{tgt}. An upper limit value Tₘₐₓ and the lower limit value Tₘᵢₙ may be set such that the estimated zero load value T_{tgt} is placed at the center of the torque range. That is, the upper limit value Tₘₐₓ is obtained by adding a predetermined torque ΔT to the estimated zero load value T_{tgt}, and the lower limit value Tₘᵢₙ is obtained by subtracting the predetermined torque ΔT from the estimated zero load value T_{tgt}. From time t₁, by starting shaking control, the MG1 torque T_{mg1} increases from the lower limit value Tₘᵢₙ. The MG1 torque T_{mg1} continues to increase to the upper limit value Tₘₐₓ through the estimated zero load value T_{tgt} and, after that, continues to reduce from the upper limit value Tₘₐₓ to the lower limit value Tₘᵢₙ through the estimated zero load value T_{tgt}. The magnitude of the MG1 torque T_{mg1} changes so as to alternately repeatedly increase and reduce within the torque range. In this way, by changing the torque in the increasing direction and in the reducing direction with respect to the estimated zero load value T_{tgt}, it is possible to easily release the dog clutch D by cancelling out the actual load F even when there is an error in the estimated zero load value T_{tgt}. The torque range is set such that the direction of the MG1 torque T_{mg1} is not reversed.

During shaking control, the magnitude of the MG1 torque T_{mg1} and the magnitude of the input torque Tₑ_{_}ₛ balance with each other (time t₂). In the example shown in FIG. 6, the input torque Tₑ_{_}ₛ and the MG1 torque T_{mg1} intersect with each other at a portion surrounded by the dashed line B. In this way, the load F of the meshing portion 20 becomes zero as a result of the fact that the positive torque and negative torque that act on the MG1 shaft 2b balance with each other. Therefore, it is possible to cancel out the load F of the meshing portion 20 by executing shaking control during releasing control. In addition, because shaking control is executed during releasing control, the clutch actuator 30 is not activated. For this reason, in a state where the load F is zero, the sleeve 23 moves in the releasing direction under the elastic force of the return spring 37, and the meshed state of the meshing portion 20 is released.

As in the case just after time t₁ shown in FIG. 6, when the MG1 torque T_{mg1} is smaller than the input torque Yₑ_{_}ₛ, the load F is occurring as in the case of the state shown in FIG. 5. On the other hand, when the MG1 torque T_{mg1} is larger than the input torque Tₑ_{_}ₛ, the load F occurs due to the MG1 torque T_{mg1}. In short, even when the MG1 torque T_{mg1} is caused to act in a direction to reduce the load F caused by the input torque Tₑ_{_}ₛ, the MG1 torque T_{mg1} may become the cause of the load F. Although not shown in the drawing, the negative load F₁ that the spline teeth 21a of the hub 21 push the spline teeth 22a of the fixed member 22 and the positive load F₂ that occurs in order for the fixed member 22 to restrict rotation of the hub 21 occur in this case. That is, as a result of the fact that the hub 21 that has received the negative MG1 torque T_{mg1} causes the negative load F₁ to act on the fixed member 22, the positive load F₂ occurs as a reaction.

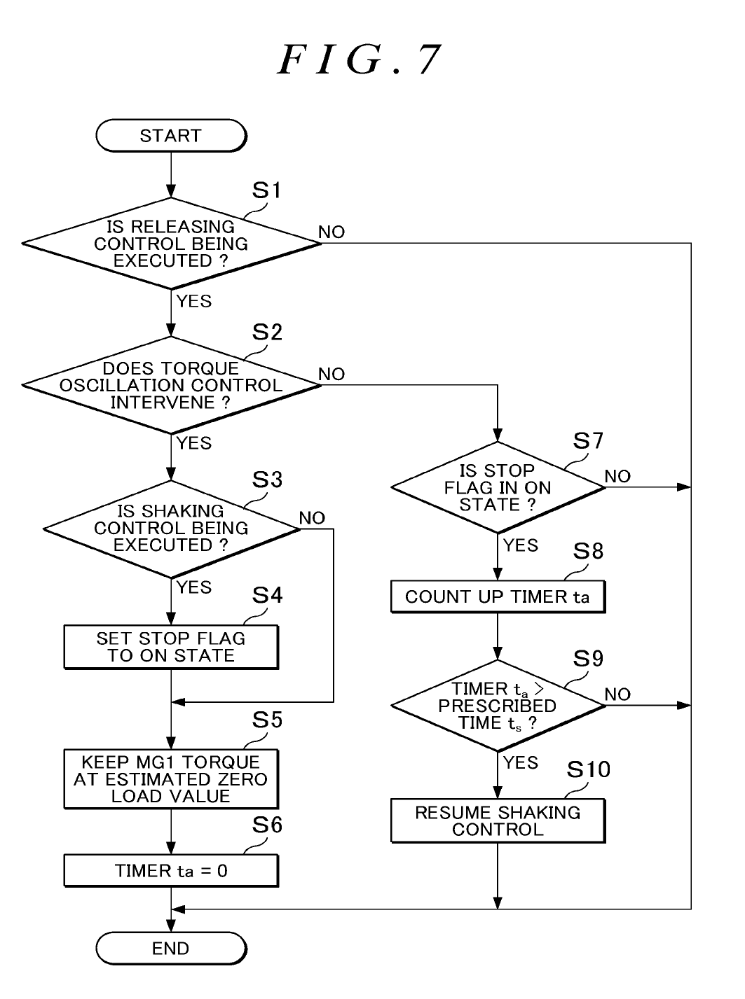

FIG. 7 is a flowchart that shows a control procedure that the control apparatus 100 for a vehicle executes while the dog clutch D is being released as an example of a control method for a vehicle according to the present embodiment.

The stop control determination unit 43a determines whether the clutch control unit 42b is executing releasing control (step S1). When negative determination is made in step S1 as a result of the fact that the clutch control unit 42b is not executing releasing control, the control routine is ended.

When the stop control determination unit 43a makes affirmative determination in step S1 that the clutch control unit 42b is executing releasing control, the torque oscillation control determination unit 43b determines whether the torque oscillation control unit 42c executes torque oscillation control (step S2). In step S2, it is determined whether to start torque oscillation control while releasing control is being executed. That is, in step S2, it is determined whether the state of control over the vehicle Ve is a state where both releasing control and torque oscillation control are executed. When affirmative determination is made in step S2, the shaking control determination unit 43c determines whether the shaking control unit 42e is executing shaking control (step S3).

When affirmative determination is made in step S3, the stop control unit 42g causes the shaking control unit 42e to stop shaking control and sets the stop flag to the on state (step S4). In step S4, the stop control unit 42g executes stop control. The keeping control unit 42f keeps the MG1 torque T_{mg1} at the estimated zero load value T_{tgt} estimated by the target MG1 torque setting unit 44c (step S5). When negative determination is made in step S3 as a result of the fact that the shaking control unit 42e is not executing shaking control as well, the process proceeds to step S5. The timer control unit 42h sets the timer tₐ to zero (step S6).

When negative determination is made in step S2, the stop flag determination unit 43d determines whether the stop flag is in the on state (step S7). When negative determination is made in step S7, the control routine is ended.

When affirmative determination is made in step S7, the timer control unit 42h counts up the timer tₐ (step S8). For example, the timer control unit 42h is configured to count up the timer tₐ in response to the number of times step S8 is processed. When the timer tₐ is 0, the timer control unit 42h counts up the timer tₐ to 1.

The timer determination unit 43e determines whether the timer tₐ is longer than the prescribed time tₛ (step S9). When negative determination is made in step S9, the control routine is ended. When affirmative determination is made in step S9, the shaking control unit 42e resumes shaking control (step S10). In step S10, the shaking control unit 42e sets the stop flag to the off state. The sequence of step S1 and step S2 of the above-described control procedure is not limited. That is, the control procedure may be configured such that, when the torque oscillation control determination unit 43b determines that torque oscillation control is being executed and then the stop control determination unit 43a determines that releasing control is being executed, the process proceeds to step S3.

FIG. 8 is a timing chart for illustrating a change in torque in the case where the above-described stop control of step S4 is executed after the start of shaking control. FIG. 9 is a timing chart for illustrating a change in torque in the case where the above-described stop control of step S4 is executed before the start of shaking control. Description similar to that described above with reference to FIG. 6 is omitted.

As shown in FIG. 8, after the start of shaking control (time t₁), when it is determined that torque oscillation control is started while shaking control is being executed, the stop control unit 42g executes stop control, and stops shaking control (time t₂). At this time, the MG1 torque T_{mg1} is changed to the estimated zero load value T_{tgt} by the keeping control unit 42f, and then kept at the estimated zero load value T_{tgt}. From time t₂, the torque oscillation control unit 42c oscillates the driving torque T_{d}, so torque oscillations generated at the drive wheels 4 transmit to the engaged meshing portion 20 via the power transmission path. In FIG. 8, Tₚ indicates torque oscillations that act on the MG1 shaft 2b on the basis of oscillations of the driving torque T_{d}. The torque oscillations Tₚ are generated by imparting braking force to each of the drive wheels 4, so the torque oscillations Tₚ act on the dog clutch D as a negative torque. The load F of the meshing portion 20 becomes zero when a torque obtained by adding the torque oscillations Tₚ to the input torque Tₑ_{_}ₛ balances with the MG1 torque T_{mg1}. That is, a torque obtained by adding the input torque Tₑ_{_}ₛ that acts from the engine 1 side and the torque oscillations Tₚ that act from the drive wheels 4 side together oscillates so as to intersect with the MG1 torque T_{mg1} that is kept at the estimated zero load value T_{tgt}. Therefore, it is possible to cancel out the load F.

As shown in FIG. 9, when torque oscillation control has been already started at the start of releasing control, the MG1 torque control unit 42d executes keeping control without executing shaking control. In this case, the MG1 torque T_{mg1} is increased to the estimated zero load value T_{tgt} at the time when the first motor 2 is returned. While torque oscillation control is being executed, the MG1 torque T_{mg1} is kept at the estimated zero load value T_{tgt}.

As described above, with the control apparatus and control method for a vehicle according to the present embodiment, when control for oscillating the driving torque is executed during releasing control, shaking control for changing the magnitude of the motor torque within the predetermined range is stopped. Thus, making the engagement mechanism difficult to be released is prevented by executing shaking control during torque oscillation control, and a load on the engagement mechanism is reduced by torque oscillations that act from the drive wheel side, so it is possible to easily release the engagement mechanism. It is possible to improve the response of releasing the engagement mechanism. In addition, it is possible to reduce electric power that is consumed in order to execute shaking control, so it is possible to improve fuel economy.

The control apparatus and control method for a vehicle according to the invention are not limited to the above-described embodiment, and may be modified as needed without departing from the scope of the invention. For example, the structure of the meshing-type engagement mechanism in the embodiment of the invention is not limited as long as the meshing-type engagement mechanism is an engagement mechanism in which meshing members are engaged. As described above, the structure of the meshing-type engagement mechanism is not limited to such a structure that the meshing members are engaged with each other via the sleeve. The meshing-type engagement mechanism may be an engagement mechanism configured such that spline teeth of one of meshing members mesh with spline teeth of the other one of the meshing members. Furthermore, the meshing-type engagement mechanism may be configured as a rotation synchronization type like a synchromesh type.

In an alternative embodiment of the control apparatus 100 for a vehicle, different from the above-described embodiment, the control apparatus 100 for a vehicle according to the alternative embodiment may be configured to execute shaking control or keeping control by using an actual engine torque measured by a sensor instead of an estimated engine torque. The ECU 40 is configured to detect an actual engine torque and then execute the above-described shaking control, or the like, on the basis of the actual engine torque. In this case, the sensors 60 include a torque sensor that detects an actual engine torque. The ECU 40 is configured to detect an actual engine torque on the basis of a detected signal from the torque sensor and then estimate the load F of the meshing portion 20 on the basis of the detected actual engine torque. In the control apparatus 100 for a vehicle according to this alternative embodiment, the detection unit 41 is configured to detect an actual engine torque on the basis of a signal that is input from the torque sensor. The load estimation unit 44b is configured to calculate the estimated zero load value T_{tgt} on the basis of the actual engine torque detected by the detection unit 41. Thus, it is possible to reduce an error in the estimated zero load value T_{tgt}, so it is possible to easily release the dog clutch D.

The ECU 40 may be configured to stop shaking control in a case other than the case where the condition that torque oscillation control intervenes is satisfied. That is, the ECU 40 does not need to include the torque oscillation control unit 42c. For example, the sensors 60 may include a torque sensor that detects the driving torque T_{d}, and the torque sensor may detect torque fluctuations due to disturbance that is input from a road surface to the drive wheels 4. In this case, the ECU 40 is configured to stop shaking control by determining that torque fluctuations act on the dog clutch D on the basis of a detected signal from the torque sensor.

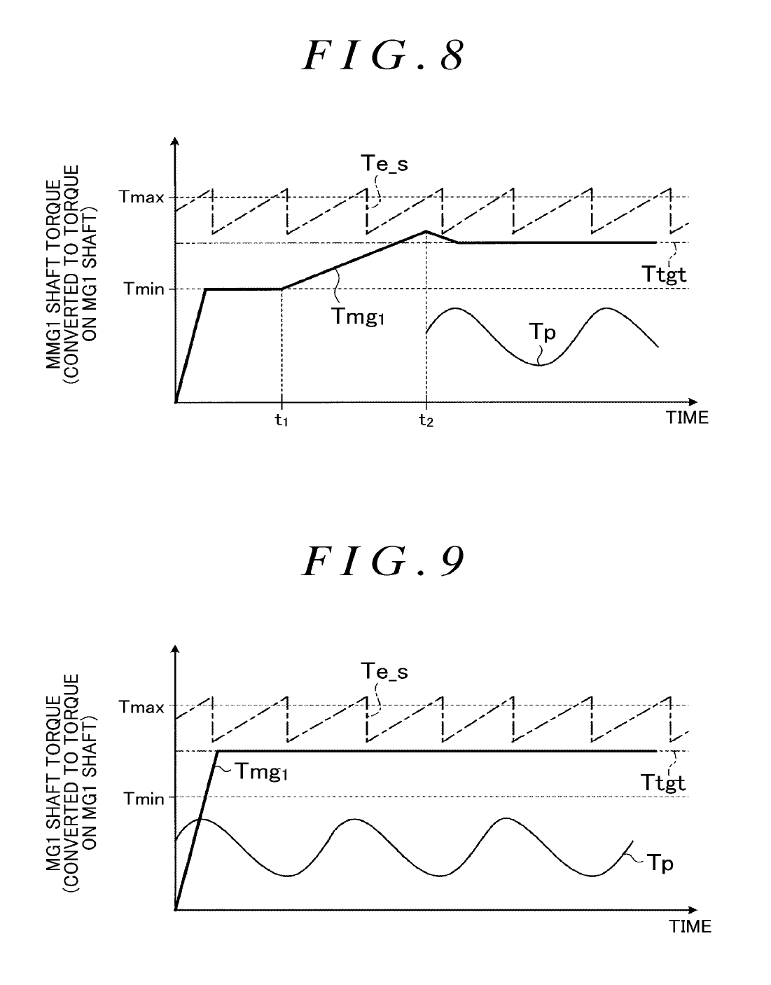

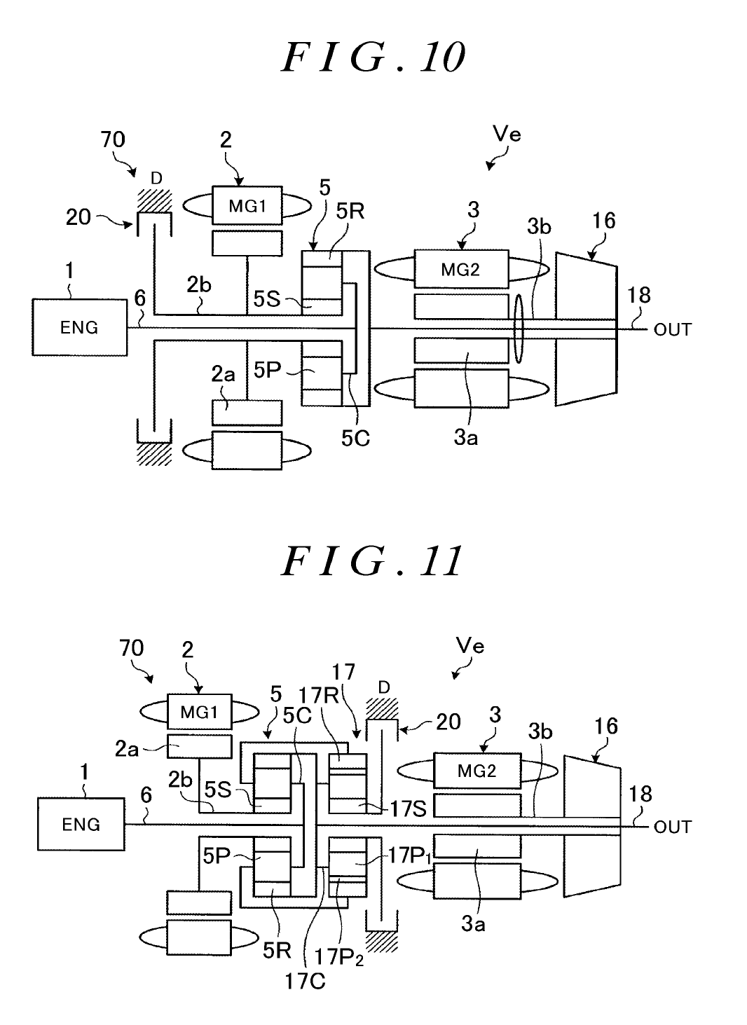

The vehicle according to the invention is not limited to the vehicle Ve including the driveline 70, shown in FIG. 1. For example, the control apparatus 100 for a vehicle may be intended for alternative embodiments of the vehicle Ve as shown in FIG. 10 to FIG. 13. Like reference numerals denote similar components to those in the above-described embodiment, and the description thereof is omitted.

The vehicle Ve according to the first alternative embodiment shown in FIG. 10, as in the case of the above-described embodiment, is configured to selectively fix the rotor shaft 2b of the first motor 2 by using the dog clutch D. In the driveline 70 of the vehicle Ve, power output from the power sources is transmitted to drive wheels OUT (not shown) via a propeller shaft 18. That is, the driveline 70 of the vehicle Ve according to the first alternative embodiment is configured as an FR system in which the power sources are arranged at the vehicle front and the driving torque T_{d} is generated at rear wheels. The motors 2, 3, the power split mechanism 5 and the propeller shaft 18 are arranged along the same axis as the rotation central axis of the engine 1. The propeller shaft 18 is coupled to the ring gear 5R of the power split mechanism 5 so as to rotate integrally with the ring gear 5R. The second motor 3 is configured to add a torque, output from the second motor 3, to the propeller shaft 18 via a transmission unit 16. The transmission unit 16 may be formed of a known transmission unit.

The vehicle Ve according to the second alternative embodiment shown in FIG. 11 is an alternative embodiment of the vehicle Ve shown in FIG. 10. The driveline 70 of the vehicle Ve according to the second alternative embodiment is configured such that the dog clutch D selectively fixes a rotating element of a transmission unit 17 formed of a planetary gear train. The transmission unit 17 functions as a speed-increasing gear when the dog clutch D is engaged. In the engaged state, an overdrive state is established. In the overdrive state, the output rotation speed of the propeller shaft 18 is higher than the input rotation speed of the output shaft 6 of the engine 1. The transmission unit 17 is formed of a double-pinion planetary gear train including three rotating elements, that is, a sun gear 17S, a carrier 17C and a ring gear 17R. The carrier 17C supports first pinion gears 17P₁ and second pinion gears 17P₂ such that the first pinion gears 17P₁ and the second pinion gears 17P₂ are rotatable and revolvable. Each of the first pinion gears 17P₁ is in mesh with the sun gear 17S. Each of the second pinion gears 17P₂ is in mesh with a corresponding one of the first pinion gears 17P₁ and the ring gear 17R. One of the meshing members of the dog clutch D is coupled to the sun gear 17S so as to rotate integrally with the sun gear 17S. The ring gear 5R of the power split mechanism 5 and the propeller shaft 18 are coupled to the carrier 17C so as to rotate integrally with the carrier 17C. The carrier 5C of the power split mechanism 5 and the output shaft 6 of the engine 1 are coupled to the ring gear 17R so as to rotate integrally with the ring gear 17R.

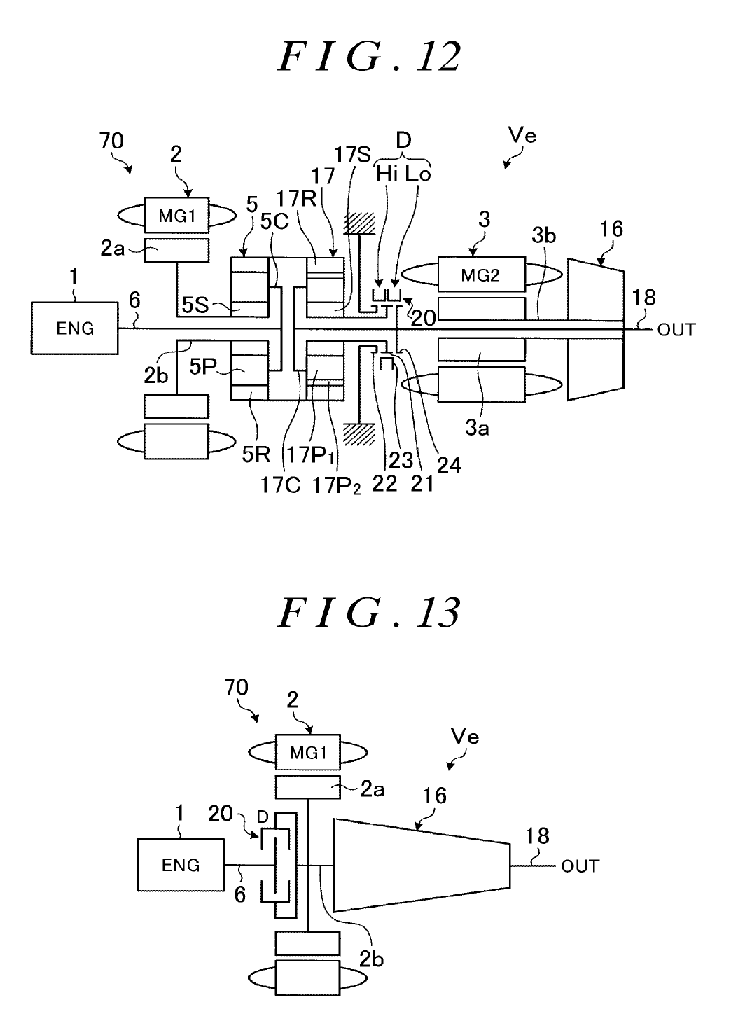

The vehicle Ve according to the third alternative embodiment shown in FIG. 12 is an alternative embodiment of the vehicle Ve shown in FIG. 11. The driveline 70 of the vehicle Ve according to the third alternative embodiment is able to rotate the rotating elements of the transmission unit 17 integrally with one another by engaging the dog clutch D. The hub 21 is coupled to the sun gear 17S so as to rotate integrally with the sun gear 17S. In a first engaged state (Hi) where the sleeve 23 is in mesh with the hub 21 and the fixed member 22, the transmission unit 17 functions as a speed-increasing gear. A second hub 24 is connected to the propeller shaft 18 so as to rotate integrally with the propeller shaft 18. In a second engaged state (Lo) where the sleeve 23 is in mesh with the hub 21 and the second hub 24, the rotating elements of the transmission unit 17 rotate integrally with one another, so the ring gear 5R of the power split mechanism 5 and the propeller shaft 18 rotate integrally with each other. In short, the dog clutch D shown in FIG. 12 is configured to be changeable into two types of engaged states (Hi, Lo). When the sleeve 23 is in a neutral position, that is, when the sleeve 23 is in mesh with the hub 21 but is not in mesh with the fixed member 22 or the second hub 24, the dog clutch D is in the released state. Therefore, the ECU 40 is configured to execute shaking control, stop control and keeping control as in the case of the above-described embodiment during releasing control for changing the dog clutch D from the first engaged state (Hi) to the released state. For the sake of convenience of description, FIG. 12 shows both an engaged position in the first engaged state (Hi) and an engaged position in the second engaged state (Lo) for the single sleeve 23.

In the vehicle Ve according to the fourth alternative embodiment shown in FIG. 13, the dog clutch D is configured to function as a clutch that disconnects the engine 1 from the driveline 70. In the driveline 70 of the vehicle Ve according to the fourth alternative embodiment, the dog clutch D is provided in a power transmission path between the engine 1 and the first motor 2. The vehicle Ve is a one-motor hybrid vehicle, and the rotor shaft 2b of the first motor 2 constitutes the input shaft of the transmission unit 16, so power output from the power sources (the engine 1 and the first motor 2) is shifted in speed in the transmission unit 16 and is transmitted to the drive wheels. The dog clutch D shown in FIG. 13 is rotatable in the engaged state. For this reason, the direction to reduce the load F of the meshing portion 20 is the same direction as the direction of the input torque Tₑ_{_}ₛ (engine inertia torque). For example, when the dog clutch D is released, the engine 1 is disconnected from the power transmission path, so the engine 1 is stopped. At this time, the engine inertia torque acts on the input-side engagement element (one of the meshing members) of the dog clutch D as the positive input torque Tₑ_{_}ₛ. In this case, the direction to reduce the load F is the same direction as the input torque Tₑ_{_}ₛ. Therefore, the shaking control unit 42e executes shaking control such that the positive MG1 torque T_{mg1} is output from the first motor 2 and the magnitude of the positive MG1 torque T_{mg1} changes within the predetermined range. Thus, the positive MG1 torque T_{mg1} acts on the output-side engagement element (the other one of the meshing members) of the dog clutch D to reduce the load F.

What is claimed is:

1. A control apparatus for a vehicle including
an engine,
a motor,
an engagement mechanism configured to change between an engaged state where a pair of meshing members are engaged with each other and a released state where the meshing members are released from each other,
a driveline configured to transmit an engine torque output from the engine to drive wheels, and
a braking device configured to impart braking force to each of the drive wheels,
when the engagement mechanism is in the engaged state, the engine torque, a motor torque output from the motor, and a torque that is transmitted from the drive wheels via the driveline being transmitted to the meshing members,
the control apparatus comprising:
an electronic control unit configured to
i) while the engagement mechanism is changing from the engaged state to the released state, execute shaking control, the shaking control being control for causing the motor to output a torque for reducing a load on the meshing members, which occurs due to the engine torque, and repeatedly increasing and reducing a magnitude of the motor torque within a predetermined range,
ii) execute torque oscillation control, the torque oscillation control being control for oscillating a torque of the drive wheels by using the braking device,
iii) determine whether to execute any one of releasing control and the torque oscillation control while the other one of the releasing control and the torque oscillation control is being executed, the releasing control being control for changing the engagement mechanism from the engaged state to the released state, and
iv) stop the shaking control when the electronic control unit determines to execute the releasing control and the torque oscillation control.

2. The control apparatus according to claim 1, wherein
the electronic control unit is configured to
v) estimate the load based on the engine torque, and execute estimation control, the estimation control is control for estimating a magnitude of a torque that cancels out the estimated load, and
vi) execute control for keeping the magnitude of the motor torque at the magnitude of the torque estimated through the estimation control, when the electronic control unit determines to execute the releasing control and the torque oscillation control.

3. A control method for a vehicle including
an engine,
a motor,
an engagement mechanism configured to change between an engaged state where a pair of meshing members are engaged with each other and a released state where the meshing members are released from each other,
a driveline configured to transmit an engine torque, output from the engine, to drive wheels,
a braking device configured to impart braking force to each of the drive wheels, and
an electronic control unit configured to, when the engagement mechanism is in the engaged state, control the vehicle such that the engine torque, a motor torque output from the motor, and a torque that is transmitted from the drive wheels via the driveline are transmitted to the meshing members,
the control method comprising:
i) while the engagement mechanism is changing from the engaged state to the released state, executing shaking control, the shaking control being control for causing the motor to output a torque for reducing a load on the meshing members, which occurs due to the engine torque, and repeatedly increasing and reducing a magnitude of the motor torque within a predetermined range;
ii) executing torque oscillation control, the torque oscillation control being control for oscillating a torque of the drive wheels by using the braking device,
iii) determining whether to execute any one of releasing control and the torque oscillation control while the other one of the releasing control and the torque oscillation control is being executed, the releasing control being control for changing the engagement mechanism from the engaged state to the released state; and
iv) stopping the shaking control when execution of the releasing control and the torque oscillation control is determined.

4. The control method according to claim 3, further comprising:
v) estimating the load based on the engine torque, and estimating a magnitude of a torque that cancels out the estimated load; and
vi) executing control for keeping the magnitude of the motor torque at the magnitude of the estimated torque, when the execution of the releasing control and the torque oscillation control is determined
